(19) United States
(12) Patent Application Publication
(10) Pub. No.: US 2010/0282743 A1
(43) Pub. Date: Nov. 11, 2010

(54) Package for Containing and Dispensing a Food Item

(76) Inventors: Steven A. Blase, Manchester, NH (US); Michael D. Sweet, Penacook, NH (US)

Correspondence Address: WOMBLE CARLYLE SANDRIDGE & RICE, PLLC, ATTN: PATENT DOCKETING, P.O. BOX 7037, ATLANTA, GA, 30357-0037, US

(21) Appl. No.: 12/639,271

(22) Filed: Dec. 16, 2009

Related U.S. Application Data
(63) Continuation of application No. PCT/US2008/067628, filed on Jun. 20, 2008.
(60) Provisional application No. 60/945,490, filed on Jun. 21, 2007.

(51) Int. Cl. H05B 6/80; B65D 5/54; B65B 1/04

(52) U.S. Cl. 219/730; 229/200; 53/473

(57) ABSTRACT

A package for dispensing a food item includes a container for holding the food item and a dispensing flap foldably attached to the container for incrementally withdrawing the food item from the container.

### CROSS-REFERENCE TO RELATED APPLICATIONS

This application is a continuation of International Application No. PCT/US2008/067628, filed Jun. 20, 2008, which claims the benefit of U.S. Provisional Application No. 60/945,490, filed Jun. 21, 2007, both of which are incorporated by reference herein in their entirety.

### TECHNICAL FIELD

The present disclosure generally relates to packages for holding and dispensing food items.

### SUMMARY

There is a need for an improved package or other construct that facilitates transportation and consumption of a food item.

Accordingly, in one aspect, the present disclosure is directed generally to a package for containing and/or dispensing a food item. The package generally comprises a sleeve or other container for receiving the food item and a dispensing (or “dispenser”) flap movably received within the sleeve. The food item may be seated on the dispensing flap. The dispensing flap and food item supported thereon may be incrementally withdrawn from the sleeve. In another aspect, the present disclosure is directed generally to a blank for forming such a package. In yet another aspect, the disclosure is directed generally to a method of containing and dispensing a food item. The method may comprise providing a blank and forming the blank into a package for holding the food item. The food item may be heated and inserted into the package. The food item may be incrementally withdrawn from the package for consumption by a user.

In one particular aspect, the package comprises a container including opposed first and second ends a plurality of adjoined walls that define a cavity for receiving a food item, and a dispensing flap movably disposed within the cavity. The plurality of walls includes a first wall and a second wall in an opposed configuration. The dispensing flap may include a fixed end joined to the first wall proximate the first end of the container, a movable end opposite the fixed end, and a flexible portion defined by a plurality of lines of weakening in the dispensing flap. At least some of the lines of weakening may form a substantially arcuate bend for supporting the food item inside the container.

When the movable end of the dispensing flap is in a first position proximate to the first end of the second wall, the arcuate bend is proximate to the second end of the container, and when the movable end of the dispensing flap in a second position distal from the first end of the second wall, the arcuate bend is proximate to the first end of the container. In this manner, operation of the dispensing flap brings a food item seated on the arcuate bend toward the first end of the container.

In one variation, a tear line extends substantially across the dispensing flap. The tear line may have any suitable location, and in some examples, the tear line substantially bisects the dispensing flap. In such an example, the tear line is generally proximate to the second end of the container when the movable end of the dispensing flap is proximate to the first end of the second wall (i.e., when the dispensing flap is substantially inserted into the container). The tear line may define a removable portion of the dispensing flap that may be separated from the remainder of the package when it is no longer needed to actuate the dispensing flap.

In one specific example, the first wall is a front wall, the second wall is a back wall, and the plurality of walls further includes a pair of opposed side walls between the front wall and the back wall. The plurality of walls may further include a bottom wall at the second end of the container. The bottom wall may include a locking feature adapted to be received within a receptacle, for example, an aperture in the front wall proximate the second end of the container.

In another aspect, a method of containing and dispensing a food item comprises providing a package, for example, such as described above, placing a food item on the flexible portion of dispensing flap within the cavity such that at least some of the lines of weakening form a substantially arcuate bend for supporting the food item, and moving the movable end of the dispensing flap away from the first end of the container, thereby urging the food item toward the first end of the container.

A blank for forming a package, for example, such as described above, may include a front wall panel, a pair of side wall panels joined to the front wall panel along respective opposed fold lines extending in a first direction, a back panel portion joined to each side wall panel along a respective fold line extending in the first direction, and a dispensing flap joined to the front wall panel along a fold line extending in a second direction substantially perpendicular to the first direction. The dispensing flap may include a plurality of lines of weakening (e.g., fold lines, score lines, and/or tear lines, etc.) extending substantially across the dispensing flap in the second direction.

In one variation, each side wall panel includes a front portion joined to the front wall panel and a rear portion joined to the respective back panel portion. In another variation, the blank further includes a pair of bottom wall portions respectively joined to the back wall portions along respective fold lines extending in the second direction. A locking tab portion may extend from each bottom wall portion. In such variations, the front wall panel may be configured to receive the locking tab portions.

Any of the various blanks and/or packages contemplated by the disclosure may include a microwave energy interactive element that alters the effect of microwave energy on the food item contained in the package.

Other features, aspects, and embodiments of the invention will be apparent from the following description, accompanying figures, and appended claims.

### BRIEF DESCRIPTION OF THE DRAWINGS

The description refers to the accompanying drawings in which like reference characters refer to like parts throughout the several views, and in which:

FIG. 1A is a schematic perspective view of the front of a package for holding and dispensing a food item;

FIG. 1B is a schematic perspective view of the rear of the package of FIG. 1A;

FIG. 1C is a schematic perspective view of the bottom of the package of FIGS. 1A and 1B;

FIGS. 1D and 1E are schematic perspective views of the package of FIGS. 1A-1C in use;

FIG. 1F is a schematic plan view of a blank that may be used to form the package of FIGS. 1A-1E; and

FIG. 1G is a schematic perspective view of the package of FIGS. 1A-1E in a partially constructed configuration.

### DETAILED DESCRIPTION

Various aspects of the disclosure may be illustrated by referring to the figures. For purposes of simplicity, like numerals may be used to describe like features. It will be understood that where a plurality of similar features are depicted, not all of such features necessarily are labeled on each figure. Although several different exemplary aspects, implementations, and embodiments are provided, numerous interrelationships between, combinations thereof, and modifications of the various inventions, aspects, implementations, and embodiments are contemplated hereby.

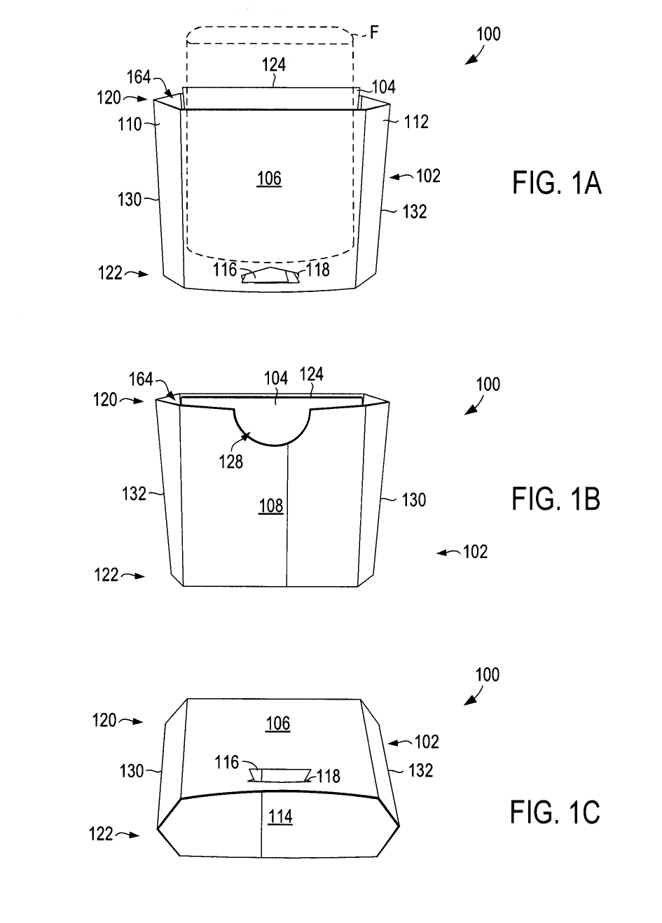

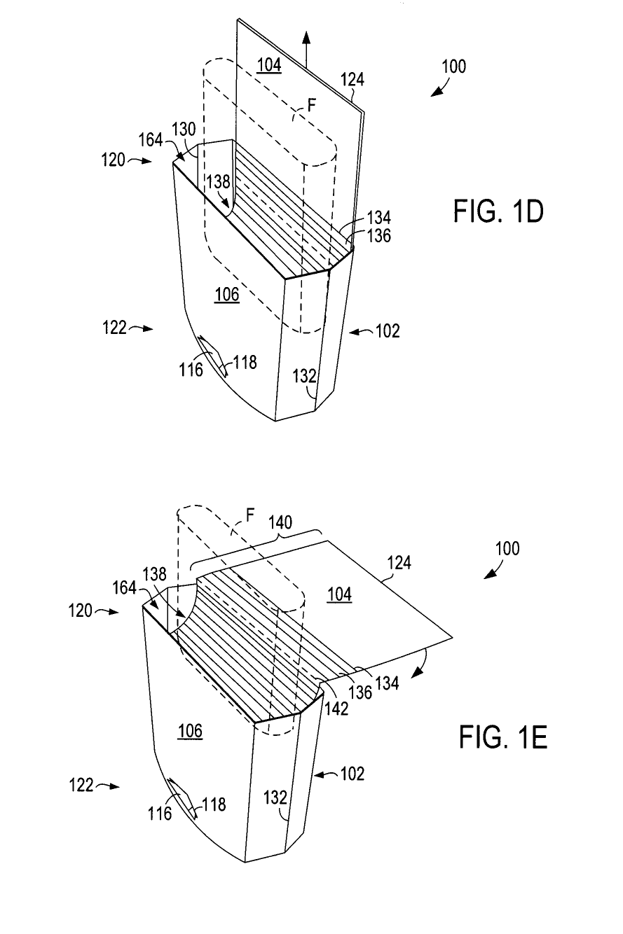

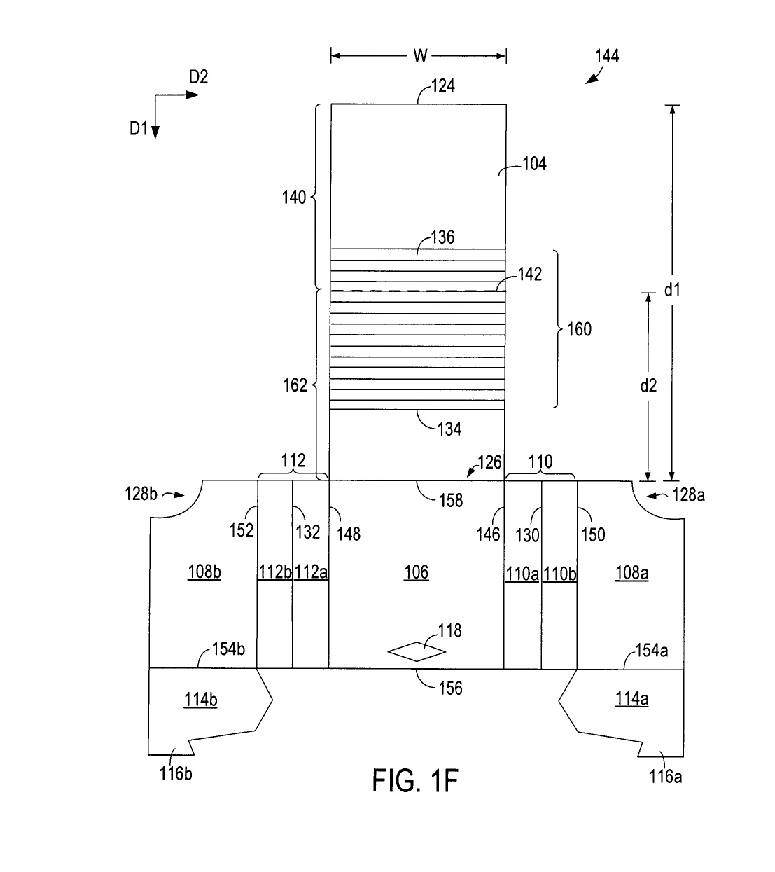

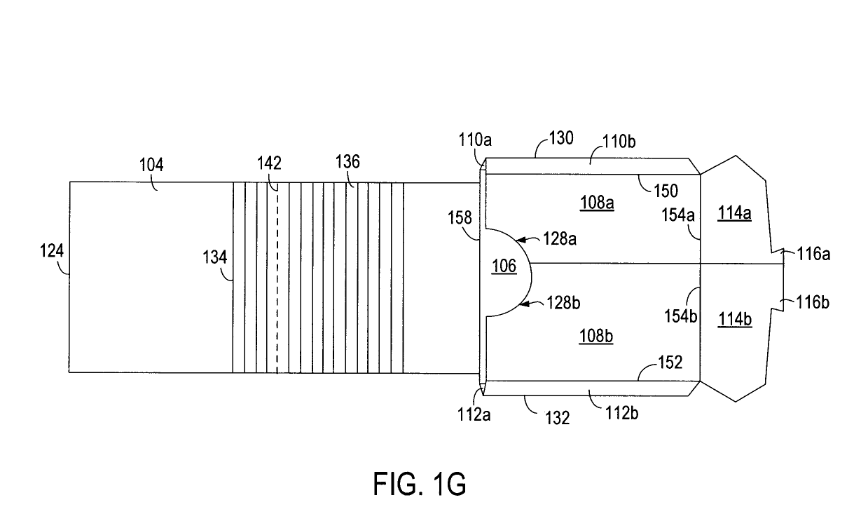

FIGS. 1A-1E schematically depict an exemplary package 100 for holding and dispensing a food item, such as a sandwich, calzone, turnover, burrito, or any other food item. The package 100 generally includes a container (e.g. a sleeve) 102 for receiving a food item F (shown schematically with dashed lines in FIGS. 1A, 1D, and 1E) and a dispensing flap 104 movably received within (and optionally attached to) the sleeve 102 for supporting the food item and allowing a user to incrementally withdraw the food item from the sleeve 102. If desired, the package 100 may be used to contain the food item before, during, and/or after heating, for example, in a microwave oven. Accordingly, the package 100 may include one or more microwave energy interactive elements (not shown) that alter the effect of microwave energy on the food item, as will be discussed further below. Where the food item is heated in a microwave oven or otherwise, the sleeve 102 may provide thermal insulation to protect the user's hand from the heated food item.

The sleeve 102 includes a front wall 106, back wall 108, pair of opposed side walls 110, 112, and a bottom wall 114. The bottom wall 114 includes a locking tab 116 that extends through an aperture 118 in the front wall 106 and maintains (e.g., locks) the bottom wall 114 in a closed configuration. It will be noted that in this example, the sleeve 102 includes an open top end 120 and a closed bottom end 122. However, the sleeve 102 could have a closed top end 120 that is capable of being opened, an open bottom end 122, or any other configuration. In any of such embodiments, any suitable mechanism may be used to open and/or close an end of the sleeve. The dispensing flap 104 includes a first, movable end 124 that may be grasped by a user to operate the dispensing flap 104, and a second, fixed end 126 (best seen in FIGS. 1F and 1G) joined to the front wall 106 of the sleeve 102. The back wall 108 optionally includes an access opening 128 for accessing the first end 124 of the dispensing flap 104. In this example, the access opening 128 is substantially semi-circular in shape. However, numerous other sleeve 102 configurations are contemplated by the disclosure. For example, in the illustrated embodiment, the side walls 110, 112 include respective lines of weakening 130, 132 (e.g. fold lines) that allow the package to be collapsed into a flattened configuration and/or to accommodate the shape of the food item F. However, the various other walls may include such lines of weakening and/or numerous other features that facilitate manufacture, assembly, and/or use of the package.

As shown schematically in FIGS. 1D and 1E, the dispensing flap 104 includes a plurality of lines of weakening 134 (only one of which is labeled) that define a plurality of independently movable sections 136 (only one of which is labeled) in the dispensing flap 104. When the dispensing flap 104 is positioned within the sleeve 102, at least some of the independently movable sections 136 form a somewhat C-shaped or arcuate bend 138 for supporting the food item F. As the dispensing flap 104 is inserted into and withdrawn from the sleeve 102, the independently movable sections 136 allow the dispensing flap 104 to flexibly bend or curl downwardly and upwardly, respectively, in a substantially smooth motion with various sections 136 of the dispensing flap 104 defining the arcuate bend 138 at various heights within the sleeve 102. As the dispensing flap 104 is withdrawn, the position of the arcuate bend 138 approaches the open end 120 of the sleeve 102. As the dispensing flap 104 is urged inwardly, the position of the arcuate bend 138 approaches the bottom wall 114 of the sleeve 102 and the dispensing flap 104 has an overall U-shape. Accordingly, when a food item F is seated on the arcuate bend 138, the food item F is likewise respectively raised or lowered when the dispensing flap 104 is withdrawn or urged into the sleeve 102, thereby allowing the food item F to be accessed and/or handled more readily.

For example, in FIG. 1A, a portion of the food item F extends above the open top end 120 of the sleeve 102. As the food item F is consumed, the sleeve 102 may interfere with accessing the food item F. The user then may grasp the first end 124 of the dispensing flap 104 and withdraw the dispensing flap 104 from the sleeve 102 to the extent needed to raise the food item F to the desired height, as shown in FIG. 1D. In doing so, the user can control the amount of food item F that is exposed above the top of the sleeve 102 by selectively withdrawing the dispenser flap 104.

If desired, the dispensing flap 104 may include one or more lines of weakening that define a removable portion 140 of the dispensing flap 104, as shown in FIG. 1E. In this example, the dispensing flap 104 includes a tear line 142 extending substantially across the dispensing flap 104. The tear line 142 allows a portion of the dispensing flap 104 to be detached from the remainder of the dispensing flap 104 when the dispensing flap 104 has been withdrawn sufficiently and is no longer needed or desired to operate the dispensing flap 104. Alternatively, the tear line 142 may serve as a fold line to allow the unneeded portion of the dispensing flap 104 to be folded downwardly (in the direction of the arrow in FIG. 1E) against the outer surface of the back wall 108. The tear line 142 also may serve as a line of weakening that operates in connection with the arcuate bend 138.

FIG. 1F is a plan view of a blank 144 that may be used to form the package 100 of FIGS. 1A-1E. The blank 144 generally includes a plurality of adjoined panels, each of which has a first dimension, for example, a length, extending in a first direction, for example, a longitudinal direction, D1, and a second dimension, for example, a width, extending in a second direction, for example, a transverse direction, D2. It will be understood that such designations are made only for convenience and do not necessarily refer to or limit the manner in which the blank 144 is manufactured or erected into a construct (e.g. a package).

The blank 144 includes a front wall panel 106 foldably connected to a first side wall panel 110 along a longitudinal fold line 146 and a second side wall panel 112 foldably connected to the front panel 106 along a longitudinal fold line 148. A first back wall portion 108a is foldably connected to the first side wall panel 110 along a longitudinal fold line 150, and a second back wall portion 108b is foldably connected to the second side wall panel 112 along a longitudinal fold line 152. Each back wall portion 108a, 108b includes a notch 128a, 128b at a top corner of the respective back wall portion 108a, 108b.

The first back wall portion 108a is foldably connected to a first bottom wall portion 114a along a transverse fold line 154a. The second back wall portion 108b is foldably connected to a second bottom wall portion 114b along a transverse fold line 154b. In the illustrated embodiment, the bottom wall portions 114a, 114b each include a locking tab portion 116a, 116b at the lower end of the respective bottom wall portion 114a, 114b. The front wall panel 106 includes a diamond-shaped aperture 118 generally near a lowermost transverse edge 156 of the front wall panel 106. The aperture 118 is dimensioned to receive the locking tab portions 116a, 116b, as will be discussed further below.

Still viewing FIG. 1F, the first side wall panel 110 includes a front portion 110a foldably attached to the front wall panel 106 along longitudinal fold line 146 and a rear portion 110b foldably attached to the front portion 110a along longitudinal fold line 130. Likewise, the second side wall panel 112 includes a front portion 112a foldably attached to the front wall panel 106 along fold line 148 and a rear portion 112b foldably attached to the front portion 112a along longitudinal fold line 132. Alternatively, one or both of the side wall panels 110, 112 could comprise a single portion (i.e., fold line 130 and/or fold line 132 could be omitted) without departing from the disclosure. The opposite longitudinal edges of the rear portions 110b, 112b are foldably attached to respective back wall portion 108a, 108b along longitudinal fold lines 150, 152, as discussed above.

The dispenser flap 104 is foldably connected to the front panel 106 along a transverse fold line 158 opposite transverse edge 156, although the flap 104 may be attached at a wide variety of other locations. In this example, the dispensing flap 104 extends away from the front panel 106 a distance d1 and has a second dimension (i.e., width W) approximately equal to the second dimension (i.e., width) of the front panel 106. However, the flap 104 may be otherwise shaped and dimensioned without departing from the scope of this disclosure.

As discussed in connection with FIGS. 1D and 1E, the dispensing flap 104 may include a plurality of transverse fold lines 134 that extend in the second direction D2 substantially across the dispensing flap 104. The fold lines 134 may be cut lines, scores, score lines, or any other mechanisms of weakening. The various fold lines (or other lines of weakening) 134 and the movable sections 136 between such fold lines 134 define a flexible section or portion 160 of the dispensing flap 104 that facilitates insertion and withdrawal of the dispensing flap 104 from the sleeve 102 and formation of the arcuate bend 138 (FIGS. 1D and 1E).

In the illustrated embodiment, the fold lines 134 are spaced evenly along a portion of the length of the flap 104. The upper edge margin of the dispenser flap 104 is substantially free from fold lines, and the lower edge margin is substantially free from fold lines. However, other spacing and configurations are contemplated. In each of various examples, adjacent fold lines 134 may be spaced apart a distance of from about 1 mm to about 15 mm, from about 2 to about 10 mm, from about 3 to about 8 mm, about 1 mm, about 2 mm, about 3 mm, about 4 mm, about 5 mm, about 6 mm, about 7 mm, about 8 mm, about 9 mm, about 10 mm, or any other suitable distance or range of distances.

If desired, the dispensing flap 104 may be divided into a first (removable) portion 140 and a second portion 162 by transverse tear line 142, which also overlaps with and/or serves as one of the lines of weakening 134. In this example, the tear line 142 is a distance d2 from the front wall panel 106 such that the first portion 140 and second portion 162 of the dispenser flap have substantially the same first dimension (e.g. length). However, the tear line 142 could be otherwise located, could be omitted, or could include or be combined with other mechanisms of weakening (e.g., a fold line), without departing from the disclosure. In the illustrated example, four fold lines 134 extend across the first portion 140 (above tear line 142) and eleven fold lines 134 extend across the second portion 162 (below tear line 142). However, other numbers and arrangements of lines of weakening are contemplated by the disclosure.

To construct the package 100 from the blank 144 according to one exemplary method, the side wall panels 110, 112 may be brought towards one another by folding along respective longitudinal fold lines 146, 148. Likewise, the back wall portions 108a, 108b may be brought towards one another by folding along respective longitudinal fold lines 150, 152, such that the back wall portions 108a, 108b are spaced apart from the front wall panel 106 by the side walls 110, 112, as shown in FIG. 1G.

The back wall panels 108a, 108b, bottom wall portions 114a, 114b, and locking tab portions 116a, 116b may be at least partially overlapped and joined to one another adhesively, thermally, mechanically, or otherwise to respectively form the back wall 108 (FIG. 1B) and bottom wall 114 (FIG. 1C) of the sleeve 102 and the locking tab 116 (FIGS. 1A, 1B, 1D, 1E). Likewise, notches 128a, 128b cooperate to form the access opening 128 along the top edge 120 of the back wall 108 of the sleeve 102.

The bottom of the sleeve 102 may be closed by folding the bottom wall panel 108 along overlapped transverse fold lines 154a, 154b and inserting the locking tab 116 into the aperture 118 in the front panel 106 (FIG. 1C). In this configuration, the front wall 106, back wall 108, and side walls 110, 112 define a cavity 162 for receiving the dispensing flap 104 on which the food item may be seated (FIG. 1A).

The dispensing flap 104 then may be folded towards the front wall 106 along fold line 158 and loaded into the sleeve 102. The various fold lines 134 allow the dispensing flap 104 to be flexibly loaded into the sleeve 102 and define the arcuate bend 138 (FIGS. 1D and 1E) adjacent to the bottom wall 114 of the sleeve 102.

When the dispensing flap 104 is fully loaded in the sleeve 102, the top edge 124 of the flap is generally adjacent to the top edge 120 of the sleeve 102 and the removable portion 140 of the dispensing flap 104 generally is positioned in a facing relationship with the back wall 108. In this configuration, the dispensing flap 104 has an overall U-shape within the sleeve 102, with the transverse tear line 142 approximately located at the lowermost point of the generally arcuate bend 138.

The food item then may be loaded into the cavity 164 of the sleeve and positioned on the arcuate bend between the first portion 140 and second portion 162 of the dispensing flap 104.

The various blanks and/or constructs contemplated hereby may be formed according to numerous processes known to those in the art, including using adhesive bonding, thermal bonding, ultrasonic bonding, mechanical stitching, or any other suitable process. Any of the various layers that may be used to form the structures and/or constructs of the invention may be provided as a sheet of material, a roll of material, or a die cut material in the shape of the construct to be formed (e.g., a blank).

The blank may be formed from any suitable dimensionally stable material, for example, coated paperboard or a similar material. For example, the paperboard may have a basis weight of from about 60 to about 330 lbs/ream, for example, from about 80 to about 140 lbs/ream. The paperboard generally may have a thickness of from about 6 to about 30 mils, for example, from about 10 to about 28 mils. In one particular example, the paperboard has a thickness of about 12 mils. Any suitable paperboard may be used, for example, a solid bleached or solid unbleached sulfate board, such as SUS® board, commercially available from Graphic Packaging International.

The blank can also be constructed of other materials, such as cardboard, hard paper, or any other material having properties suitable for enabling the package to function at least generally as described above. The blank can also be laminated to or coated with one or more sheet-like materials at selected panels or panel sections.

In one example, the dispenser flap 104 is made from the same dimensionally stable material (e.g., paperboard) as the remainder of the blank 144 and is made flexible by the presence of fold lines 134 (or other lines of weakening). The dispenser flap 104 may have fewer or more fold lines 134, and any of such fold lines may be arranged in any suitable manner, as needed to provide the desired degree of flexibility. In other examples, the dispensing flap 104 could comprise other materials (e.g., thin films or webs) that are flexible without the need for fold lines 134.

Optionally, one or more portions, panels, or sections of the various blanks and/or constructs described herein or contemplated hereby may be coated with varnish, clay, or other materials, either alone or in combination. The coating may then be printed over with product advertising, graphics, or other information or indicia. The blanks and/or constructs also may be coated to protect any information printed thereon. Furthermore, the blanks and/or constructs may be coated with, for example, a moisture barrier layer, on either or both sides.

Alternatively or additionally, any of the blanks and/or constructs of the present invention may be coated or laminated with other materials to impart other properties, such as absorbency, repellency, opacity, color, printability, stiffness, or cushioning. For example, absorbent susceptors are described in U.S. Provisional Application No. 60/604,637, filed Aug. 25, 2004, and U.S. Patent Application Publication No. US 2006/0049190 A1, published Mar. 9, 2006.

In some applications, the package may be intended for holding and/or dispensing a heated food item before, during, and/or after heating in a microwave oven or a conventional oven. In such instances, the sleeve may provide thermal insulation to protect the user's hand from the warmth of the heated food item. It will be understood that the food item may be placed into the package at any suitable time before, during, or after heating.

Where the food item is intended to be heated in a microwave oven, the package may include one or more microwave energy interactive elements that alter the effect of microwave energy on the adjacent food item. Each microwave interactive element comprises one or more microwave energy interactive materials or segments arranged in a particular configuration to absorb microwave energy, transmit microwave energy, reflect microwave energy, or direct microwave energy, as needed or desired for a particular microwave heating construct and food item. The microwave energy interactive element may be configured to promote browning and/or crisping of a particular area of the food item, to shield a particular area of the food item from microwave energy to prevent overcooking thereof, or to transmit microwave energy towards or away from a particular area of the food item.

For example, the microwave interactive element may comprise a thin layer of microwave energy interactive material (generally less than about 100 angstroms in thickness, for example, from about 60 to about 100 angstroms in thickness) that tends to absorb at least a portion of impinging microwave energy and convert it to thermal energy (i.e., heat) at the interface with the food item. Susceptor elements often are used to promote browning and/or crisping of the surface of a food item. In this example, the blank 144 and/or package 100 may include a susceptor on the side of the dispensing flap 104 in contact with the food item, the interior faces of the side walls 110, 112, or in any other suitable location.

In another example, the microwave energy interactive element may comprise a foil having a thickness sufficient to shield one or more selected portions of the food item from microwave energy. Such “shielding elements” may be used where the food item is prone to scorching or drying out during heating.

The shielding element may be formed from various materials and may have various configurations, depending on the particular application for which the shielding element is used. Typically, the shielding element is formed from a conductive, reflective metal or metal alloy, for example, aluminum, copper, or stainless steel. The shielding element generally may have a thickness of from about 0.000285 inches to about 0.05 inches. In one example, the shielding element may have a thickness of from about 0.0003 inches to about 0.03 inches. In another example, the shielding element may have a thickness of from about 0.00035 inches to about 0.020 inches, for example, about 0.016 inches.

As still another example, the microwave energy interactive element may comprise a segmented foil, such as, but not limited to, those described in U.S. Pat. Nos. 6,204,492, 6,433,322, 6,552,315, and 6,677,563. Although segmented foils are not continuous, appropriately spaced groupings of such segments may act as a shielding element. Such foils also may be used in combination with susceptor elements and, depending on the configuration and positioning of the segmented foil, the segmented foil may operate to direct microwave energy and promote heating rather than to shield microwave energy.

If desired, any of the numerous microwave energy interactive elements described herein or contemplated hereby may be substantially continuous, that is, without substantial breaks or interruptions, or may be discontinuous, for example, by including one or more microwave energy transparent areas or apertures that transmit microwave energy therethrough. Such areas may be sized and positioned to heat particular areas of the food item selectively. The areas may extend through the entire structure, or only through one or more layers. The number, shape, size, and positioning of such microwave energy transparent areas may vary for a particular application depending on type of construct being formed, the food item to be heated therein or thereon, the desired degree of shielding, browning, and/or crisping, whether direct exposure to microwave energy is needed or desired to attain uniform heating of the food item, the need for regulating the change in temperature of the food item through direct heating, and whether and to what extent there is a need for venting.

It will be understood that each microwave energy transparent area may be a physical aperture or void in one or more layers or materials used to form the construct, or may be a non-physical “aperture”. A non-physical aperture is a microwave energy transparent area that allows microwave energy to pass through the structure without an actual void or hole cut through the structure. Such areas may be formed by simply not applying a microwave energy interactive material to the particular area, or by removing microwave energy interactive material in the particular area, or by chemically and/or mechanically deactivating the microwave energy interactive material in the particular area, as described in U.S. Pat. No. 4,865,921. While both physical and non-physical apertures allow the food item to be heated directly by the microwave energy, a physical aperture also provides a venting function to allow steam or other vapors to escape from the interior of the construct.

The arrangement of microwave energy interactive and microwave energy transparent areas may be selected to provide various levels of heating, as needed or desired for a particular application. For example, where greater heating is desired, the total inactive area may be increased. In doing so, more microwave energy is transmitted to the food item. Alternatively, by decreasing the total inactive area, more microwave energy is absorbed by the microwave energy interactive areas, converted into thermal energy, and transmitted to the surface of the food item to enhance browning and/or crisping.

If desired, the microwave energy interactive element may be supported on a microwave inactive or transparent substrate, for example, a polymer film or other suitable polymeric material, for ease of handling and/or to prevent contact between the microwave energy interactive material and the food item. As used herein the term “polymer” or “polymeric material” includes, but is not limited to, homopolymers, copolymers, such as for example, block, graft, random, and alternating copolymers, terpolymers, etc. and blends and modifications thereof. Furthermore, unless otherwise specifically limited, the term “polymer” shall include all possible geometrical configurations of the molecule. These configurations include, but are not limited to isotactic, syndiotactic, and random symmetries.

Examples of polymer films that may be suitable include, but are not limited to, polyolefins, polyesters, polyamides, polyimides, polysulfones, polyether ketones, cellophanes, or any combination thereof. Other non-conducting substrate materials such as paper and paper laminates, metal oxides, silicates, cellulosics, or any combination thereof, also may be used.

In one particular example, the polymer film comprises polyethylene terephthalate. Examples of polyethylene terephthalate films that may be suitable for use as the substrate include, but are not limited to, MELINEX®, commercially available from DuPont Teijan Films (Hopewell, Va.), and SKYROL, commercially available from SKC, Inc. (Covington, Ga.). Polyethylene terephthalate films are used in commercially available susceptors, for example, the QWIKWAVE® Focus susceptor and the MICRORITE® susceptor, both available from Graphic Packaging International (Marietta, Ga.).

The thickness of the film generally may be from about 35 gauge to about 10 mil. In each of various examples, the thickness of the film may be from about 40 to about 80 gauge, from about 45 to about 50 gauge, about 48 gauge, or any other suitable thickness.

The microwave energy interactive material may be applied to the substrate in any suitable manner, and in some instances, the microwave energy interactive material is printed on, extruded onto, sputtered onto, evaporated on, or laminated to the substrate. The microwave energy interactive material may be applied to the substrate in any pattern, and using any technique, to achieve the desired heating effect of the food item.

For example, the microwave energy interactive material may be provided as a continuous or discontinuous layer or coating including circles, loops, hexagons, islands, squares, rectangles, octagons, and so forth. Examples of various patterns and methods that may be suitable are provided in U.S. Pat. Nos. 6,765,182; 6,717,121; 6,677,563; 6,552,315; 6,455,827; 6,433,322; 6,414,290; 6,251,451; 6,204,492; 6,150,646; 6,114,679; 5,800,724; 5,759,422; 5,672,407; 5,628,921; 5,519,195; 5,424,517; 5,410,135; 5,354,973; 5,340,436; 5,266,386; 5,260,537; 5,221,419; 5,213,902; 5,117,078; 5,039,364; 4,963,424; 4,936,935; 4,890,439; 4,775,771; 4,865,921; and Re. 34,683. Although particular examples of patterns of microwave energy interactive material are shown and described herein, it should be understood that other patterns of microwave energy interactive material are contemplated by the present disclosure.

The microwave energy interactive material may be an electroconductive or semiconductive material, for example, a metal or a metal alloy provided as a metal foil; a vacuum deposited metal or metal alloy; or a metallic ink, an organic ink, an inorganic ink, a metallic paste, an organic paste, an inorganic paste, or any combination thereof. Examples of metals and metal alloys that may be suitable for use with the present invention include, but are not limited to, aluminum, chromium, copper, inconel alloys (nickel-chromium-molybdenum alloy with niobium), iron, magnesium, nickel, stainless steel, tin, titanium, tungsten, and any combination or alloy thereof.

Alternatively, the microwave energy interactive material may comprise a metal oxide. Examples of metal oxides that may be suitable for use with the present invention include, but are not limited to, oxides of aluminum, iron, and tin, used in conjunction with an electrically conductive material where needed. Another example of a metal oxide that may be suitable for use with the present invention is indium tin oxide (ITO). ITO can be used as a microwave energy interactive material to provide a heating effect, a shielding effect, a browning and/or crisping effect, or a combination thereof. For example, to form a susceptor, ITO may be sputtered onto a clear polymer film. The sputtering process typically occurs at a lower temperature than the evaporative deposition process used for metal deposition. ITO has a more uniform crystal structure and, therefore, is clear at most coating thicknesses. Additionally, ITO can be used for either heating or field management effects. ITO also may have fewer defects than metals, thereby making thick coatings of ITO more suitable for field management than thick coatings of metals, such as aluminum.

Alternatively still, the microwave energy interactive material may comprise a suitable electroconductive, semiconductive, or non-conductive artificial dielectric or ferroelectric. Artificial dielectrics comprise conductive, subdivided material in a polymeric or other suitable matrix or binder, and may include flakes of an electroconductive metal, for example, aluminum.

Although certain embodiments of this invention have been described with a certain degree of particularity, those skilled in the art could make numerous alterations without departing from the spirit or scope of this invention. Any directional references (e.g., upper, lower, upward, downward, left, right, leftward, rightward, top, bottom, above, below, vertical, horizontal, clockwise, and counterclockwise) are used only for identification purposes to aid the reader's understanding of various embodiments, and do not create limitations, particularly as to the position, orientation, or use of the invention unless specifically set forth in the claims. Joinder references (e.g., joined, attached, coupled, connected, and the like) are to be construed broadly and may include intermediate members between a connection of elements and relative movement between elements. As such, joinder references do not necessarily imply that two elements are connected directly and in fixed relation to each other.

It will be understood that in each of the various blanks and packages contemplated hereby, a “fold line” can be any substantially linear, although not necessarily straight, form of weakening that facilitates folding therealong. More specifically, but not for the purpose of narrowing the scope of the present invention, a fold line may be a score line, such as lines formed with a blunt scoring knife, or the like, which creates a crushed portion in the material along the desired line of weakness, a cut that extends partially into a material along the desired line of weakness, and/or a series of cuts that extend partially into and/or completely through the material along the desired line of weakness, or any combination of these features.

For example, one type of conventional tear line is in the form of a series of cuts that extend completely through the material, with adjacent cuts being spaced apart slightly so that a nick (e.g., a small somewhat bridging-like piece of the material) is defined between the adjacent cuts for typically temporarily connecting the material across the tear line. The nicks are broken during tearing along the tear line. Such a tear line that includes nicks can also be referred to as a cut line, since the nicks typically are a relatively small percentage of the subject line, and alternatively the nicks can be omitted from such a cut line.

It will be recognized by those skilled in the art, that various elements discussed with reference to the various embodiments may be interchanged to create entirely new embodiments coming within the scope of the present invention. It is intended that all matter contained in the above description or shown in the accompanying drawings shall be interpreted as illustrative only and not limiting. Changes in detail or structure may be made without departing from the spirit of the invention. The detailed description set forth herein is not intended nor is to be construed to limit the present invention or otherwise to exclude any such other embodiments, adaptations, variations, modifications, and equivalent arrangements of the present invention.

Accordingly, it will be readily understood by those persons skilled in the art that, in view of the above detailed description of the invention, the present invention is susceptible of broad utility and application. Many adaptations of the present invention other than those herein described, as well as many variations, modifications, and equivalent arrangements will be apparent from or reasonably suggested by the present invention and the above detailed description thereof, without departing from the substance or scope of the present invention.

While the present invention is described herein in detail in relation to specific aspects, it is to be understood that this detailed description is only illustrative and exemplary of the present invention and is made merely for purposes of providing a full and enabling disclosure of the present invention and to set forth the best mode of practicing the invention known to the inventors at the time the invention was made. The detailed description set forth herein is not intended nor is to be construed to limit the present invention or otherwise to exclude any such other embodiments, adaptations, variations, modifications, and equivalent arrangements of the present invention.

What is claimed is:

1. A package for holding and dispensing a food item, comprising:
a container including opposed first and second ends and a plurality of adjoined walls that define a cavity for receiving a food item, the plurality of walls including a first wall and a second wall in an opposed configuration; and
a dispensing flap movably disposed within the cavity, the dispensing flap including
a fixed end joined to the first wall proximate the first end of the container,
a movable end opposite the fixed end, and
a flexible portion defined by a plurality of lines of weakening in the dispensing flap, wherein at least some of the lines of weakening form a substantially arcuate bend for supporting the food item.

2. The package of claim 1, wherein
with the movable end of the dispensing flap in a first position proximate to the first end of the second wall, the substantially arcuate bend is proximate to the second end of the container, and
with the movable end of the dispensing flap in a second position distal from the first end of the second wall, the substantially arcuate bend is proximate to the first end of the container.

3. The package of claim 1, further comprising a tear line extending substantially across the dispensing flap.

4. The package of claim 3, wherein the tear line substantially bisects the dispensing flap.

5. The package of claim 3, wherein the tear line is proximate to the second end of the container when the movable end of the dispensing flap is proximate to the first end of the second wall.

6. The package of claim 3, wherein
the tear line defines a removable portion of the dispensing flap, and
the removable portion includes the movable end of the dispensing flap.

7. The package of claim 1, wherein
the first wall is a front wall,
the second wall is a back wall, and
the plurality of walls further includes a pair of opposed side walls between the front wall and the back wall.

8. The package of claim 7, wherein the plurality of walls further includes a bottom wall at the second end of the container.

9. The package of claim 8, wherein the bottom wall includes a locking feature adapted to be received in an aperture in the front wall proximate the second end of the container.

10. The package of claim 1, further comprising a microwave energy interactive element.

11. The package of claim 10, wherein the microwave energy interactive element is operative for converting at least a portion of impinging microwave energy into thermal energy.

12. The package of claim 10, wherein the microwave energy interactive element comprises a layer of microwave energy interactive material having a thickness of less than about 100 angstroms.

13. The package of claim 12, wherein the microwave energy interactive material overlies at least a portion of the dispensing flap.

14. A blank for forming a package for dispensing a food item, comprising:
a plurality of adjoined panels, each panel having a first dimension extending in a first direction and a second dimension extending in a second direction substantially perpendicular to the first direction, the plurality of adjoined panels including
a front wall panel;
a pair of side wall panels joined to the front wall panel along respective opposed fold lines extending in the first direction;
a pair of back panel portions respectively joined to the side wall panels along respective fold lines extending in the first direction; and
a dispensing flap joined to the front wall panel along a fold line extending in the second direction, the dispensing flap including a plurality of lines of weakening extending substantially across the dispensing flap in the second direction.

15. The blank of claim 14, wherein at least one of the lines of weakening is a fold line.

16. The blank of claim 14, wherein at least one of the lines of weakening is a tear line.

17. The blank of claim 14, wherein the tear line substantially bisects the dispensing flap.

18. The blank of claim 14, wherein the tear line defines a removable portion of the dispensing flap.

19. The blank of claim 14, wherein each side wall panel includes a front portion joined to the front wall panel and a rear portion joined to the respective back panel portion.

20. The blank of claim 14, further comprising a bottom wall portion joined to each back wall portion along a fold line extending in the second direction.

21. The blank of claim 14, further comprising a locking tab portion extending from each bottom wall portion.

22. The blank of claim 21, further comprising an aperture in the front wall panel, the aperture being dimensioned to receive the locking tab portion.

23. The blank of claim 14, further comprising a notch in a corner of each back panel portion distal the respective side panel to which the respective back panel portion is joined.

24. The blank of claim 14, further comprising a microwave energy interactive element.

25. The blank of claim 24, wherein the microwave energy interactive element is operative for converting at least a portion of impinging microwave energy into thermal energy.

26. The blank of claim 24, wherein the microwave energy interactive element comprises a layer of microwave energy interactive material having a thickness of less than about 100 angstroms.

27. The blank of claim 26, wherein the microwave energy interactive material overlies at least a portion of the dispensing flap.

28. A method of containing and dispensing a food item, comprising:
providing a package including
a container having opposed first and second ends and a plurality of adjoined walls that define a cavity for receiving a food item, the plurality of walls including opposed first and second walls, and
a dispensing flap movably disposed within the cavity, the dispensing flap having a fixed end joined to the first wall proximate the first end of the container, a movable end opposite the fixed end, and a flexible portion defined by a plurality of lines of weakening in the dispensing flap;
placing a food item on the flexible portion of dispensing flap within the cavity, wherein at least some of the lines of weakening form a substantially arcuate bend in the dispensing flap for supporting the food item; and
moving the movable end of the dispensing flap away from the first end of the container, thereby urging the food item toward the first end of the container.

29. The method of claim 28, wherein the container includes a microwave energy interactive material overlying the dispensing flap, the microwave energy interactive material being operative for converting at least a portion of impinging microwave energy to heat.

30. The method of claim 29, further comprising exposing the food item in the cavity to microwave energy, whereby the microwave energy interactive material converts at least a portion of the microwave energy to heat for browning and/or crisping the food item.
